(19) United States
(12) Patent Application Publication
(10) Pub. No.: US 2017/0363733 A1
(43) Pub. Date: Dec. 21, 2017

(54) Radar-Assisted Optical Tracking Method and Mission System for Implementation of This Method

(71) Applicant: THALES, Courbevoie (FR)

(72) Inventors: Gilles GUERRINI, Pessac Cedex (FR); Fabien RICHARD, Pessac Cedex (FR); Fabien CAMUS, Pessac Cedex (FR)

(21) Appl. No.: 15/541,319

(22) PCT Filed: Dec. 30, 2015
(86) PCT No.: PCT/EP2015/081425

§ 371 Date: Jun. 30, 2017

(30) Foreign Application Priority Data
Dec. 30, 2014 (FR) 14/03045

(51) Int. Cl. G01S 13/86; G01S 3/786; G01S 7/22; G01S 13/72

(52) U.S. Cl. CPC G01S 13/867; G01S 13/72; G01S 3/7864; G01S 7/22

(57) ABSTRACT

The method, implemented within a mission system that comprises an electro-optical camera which generates video images, detects movable/moving objects, and tracks a target object; and a radar sensor which generates signals and detects blips, consists of: acquiring a video image provided by the camera and blips provided by the radar sensor at the time instant of generation of the acquired video image; converting the geographic position of each acquired blip, expressed in a first reference frame associated with the radar sensor, into a geographic position expressed in a second reference frame associated with a camera pointing direction of the electro-optical camera at the time instant of generation of the video image; and correcting the geographic position of each blip in the second reference frame, according to the characteristic features of the camera, in a manner such as to obtain a position in the image.

The present invention relates to the field of mission systems for surveillance and intelligence gathering, incorporating an airborne sensing device of the electro-optical camera type.

An electro-optical camera integrates an optical camera, mounted so as to be movable on the carrier platform in a manner so as to be oriented, and an image processing chain for processing video images generated by the camera.

The processing chain allows for the detection of moving objects in the succession of the video images, by using appropriate detection algorithms.

Quite obviously, to this end, it is necessary for the actual target to be able to be detected, that is to say for to be not only within the field of view of the camera, but also to be able to be isolated in the video images, by the detection algorithms.

However, the meteorological conditions may not always allow for the detection of a target. When the sky is cloudy, the reduced visibility no longer allows for the detection of a target. An electro-optical camera is thus very sensitive to meteorological conditions.

Furthermore, an electro-optical camera is able to be oriented in a manner so as to follow a target object chosen from among the detected objects. More precisely, the camera is automatically servo-controlled on the target object. The processing chain applies a prediction algorithm that is capable of calculating an estimated position of the target object at the current time instant, on the basis of the instantaneous speed vector of the target object at the preceding time instant. A detection in the vicinity of the estimated position is considered as being a detection of the target object. It is thus possible to track a target object from image to image. This is the notion of tracking of a target object.

The tracking of a target object does not take into account the changes in direction or speed of the target between the present time instant of estimation and the preceding time instant. As a result, over extended periods of time, the tracking no longer ensures the ability to effectively predict the position of the target object and, as a consequence thereof, to associate a detection in the current image with the target object.

However, in the event of obstruction of the field of view of the camera, for example by the passing of a masking object between the camera and the target, the probability of recovering the target object upon the camera no longer being obstructed is low. Thus, the prediction is not sufficient for the purposes of enabling the tracking of this target object.

As a consequence, in difficult meteorological conditions or in the event of masking of the target object, an operator of the mission system who is looking at the video images displayed on a screen is unable to rapidly interpret what is happening in the theatre of operation.

There is therefore a need for the ability to track a target object with an electro-optical camera, even when it is not possible to detect this object, whether because of the difficult meteorological conditions or the obstruction of the field of view of the camera.

In order to solve this problem, research efforts have been conducted focusing on the fusion of data originating from an electro-optical camera and a radar sensor.

In the present patent application, a radar sensor incorporates a radar and a processing chain for processing the signal generated by the radar.

The processing chain includes a detection module for detecting objects based on echoes and a tracking module that provides the ability to track an object over time. A radar object will be referred to as a blip in the present patent application.

In a general manner, the signal generated by a radar has the operational advantage of making possible the detection of targets over a longer distance than an electro-optical camera, and of being insensitive to the meteorological conditions (at least in the appropriate frequency ranges) and to the masking of one target by another.

Currently, the recommended solutions consist of performing a radar tracking of a radar target object, and pointing the electro-optical camera on the radar target object.

However, these solutions involve a fairly lengthy and complex process of radar tracking of a large number of objects detected. Often this work is not of much use in respect of the one or more objects of interest sought by the operator. Indeed, 80% of the objects tracked by the radar sensor are objects that are of no interest for the operator.

In addition, these solutions are only implemented in the downstream phase of aiding in the identification, and thus very late in relation to the needs of the operator.

Finally, at the moment when they would like to optically observe a radar target object, the operator looks at a video image, which, if the weather is not good, does not provide them with any information that may be useful to identify the target object and determine whether it is an object of interest.

The object of the invention is thus to overcome this problem.

The subject matter of the invention relates to a radar-assisted optical tracking method, implemented within a mission system comprising an electro-optical camera which generates video images, detects movable objects, and tracks a target object, and a radar sensor which generates signals and detects blips, characterised in that it includes the following steps of: acquiring a video image provided by the electro-optical camera and blips provided by the radar sensor at the instant of generation of the acquired video image; converting the geographic position of each acquired blip, expressed in a first reference frame associated with the radar sensor, into a geographic position expressed in a second reference frame associated with a pointing direction of the electro-optical camera at the instant of generation of the video image; correcting the geographic position of each blip in the second reference frame, according to the characteristic features of the camera, in a manner such as to obtain a position in the image.

According to particular embodiments, the method includes one or more of the following characteristic features, taken into consideration individually or in accordance with all technically possible combinations:

the method includes the following steps of: adding a graphic symbol to the video image for each blip (or point), the graphic symbol being placed in the image in a manner so as to correspond to the position in the image of the associated blip; and displaying an enhanced image obtained based on the video image and the graphics added.

the method includes a step that consists of associating with each moving object detected by the electro-optical camera a possible blip, the possible blip to be associated with a moving object being the blip which is the nearest to the said moving object in the video image, augmented with added information related to the corresponding moving object;

the method includes a step that consists in estimating, in the current video image, the position of an estimated blip, using the information related to the possible blips associated with a target object in one or more preceding video images;

the method includes a step that consists of associating with each estimated blip a possible blip, the possible blip to be associated with a blip that is estimated as being the blip which is the nearest to the said estimated blip in the video image;

the method includes a step that consists of servo-controlling the electro-optical camera by making use of information related to the estimated blip or to the possible blip associated with the estimated blip corresponding to a target object.

The object of the invention also relates to a mission system that comprises a radar sensor and an electro-optical camera, characterised in that it includes a device that is capable of acquiring a video image provided by the electro-optical camera and blips provided by the radar sensor at the instant of generation of the acquired video image, and comprising: a position transformation means for transforming a geographic position of each acquired blip, expressed in a first reference frame associated with the radar sensor, into a geographic position expressed in a second reference frame associated with a pointing direction of the electro-optical camera at the instant of generation of the video image; a position correction means for correcting the geographic position of each blip in the second reference frame output from the transformation means, based on the characteristic features of the camera, such as to obtain a position in the image.

According to particular embodiments, the system includes one or more of the following characteristic features, taken into consideration individually or in accordance with all technically possible combinations:

the system includes a superposition means that is capable of adding to the video image, a graphic symbol for each blip, the graphic symbol being placed in the image in a manner so as to correspond to the position in the image of the associated blip, provided as output from the correction means, and a human/machine display interface for displaying an enhanced image obtained based on the video image and the graphics added;

the system includes a means of association that consists of associating with each moving object detected by the electro-optical camera a possible blip, the possible blip to be associated with a moving object being the blip which is the nearest to the said moving object in the current video image, supplemented with added piece of information related to the corresponding moving object;

the system includes an estimation means that is capable of estimating, in the current video image, the position of an estimated blip, using the piece of information related to the possible blips associated with a target object in one or more preceding video images;

the system includes a means of association that is capable of associating with each estimated blip a possible blip, the possible blip to be associated with an estimated blip being the blip which is the nearest to the said estimated blip in the current video image;

the system includes an additional servo-control means that is capable of command-controlling a camera pointing module of the electro-optical camera by making use of data and information related to the estimated blip or to the possible blip associated with the estimated blip corresponding to a target object.

The invention and its advantages shall be better understood upon reviewing the detailed description which follows of a particular embodiment, this description being provided purely by way of non-limiting example, with reference made to the attached drawings in which:

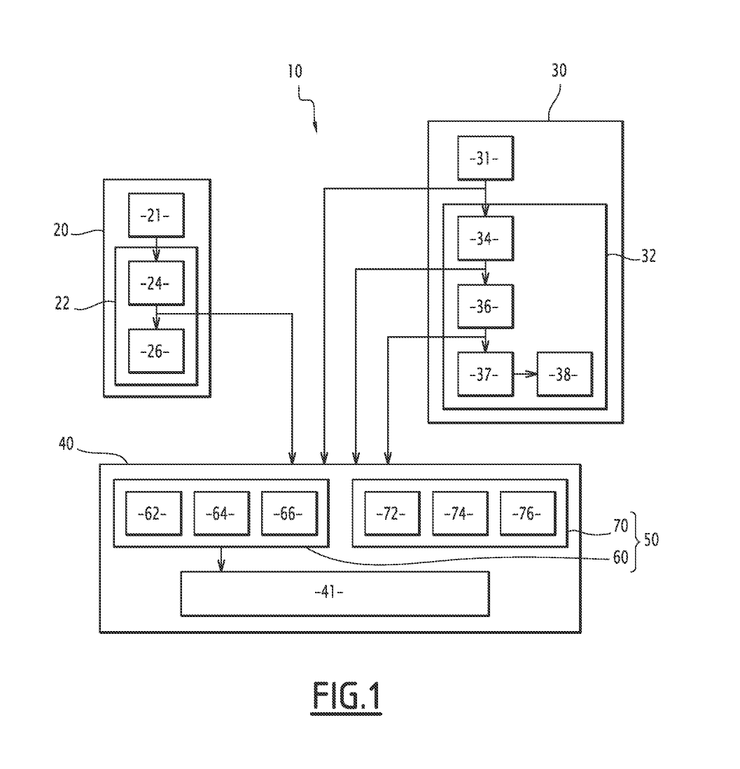

FIG. 1 is a schematic representation of a mission system according to a preferred embodiment of the invention;

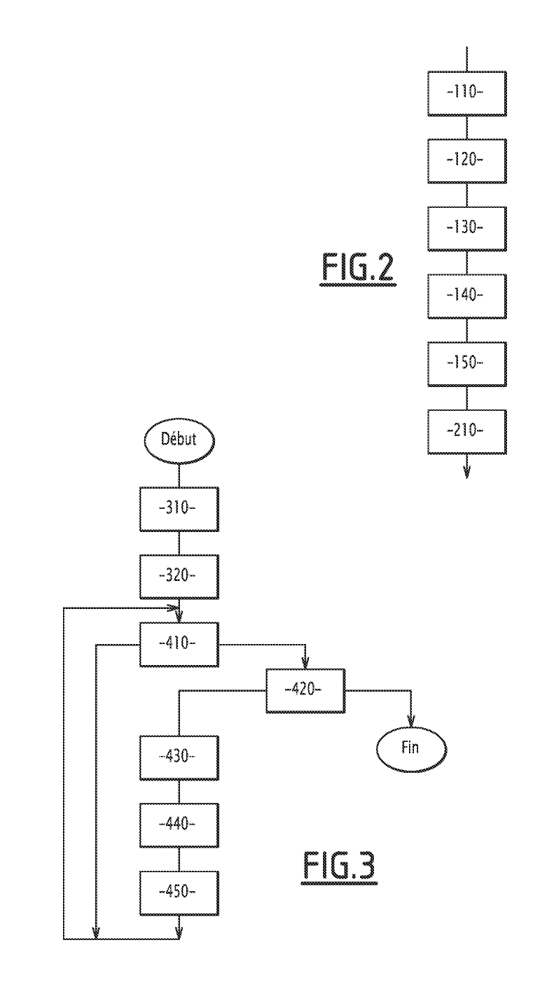

FIG. 2 is a schematic representation of an image enhancement method for enhancing of the video images of an electro-optical camera with radar blips (plot blips), performed by the system represented in FIG. 1; and,

FIG. 3 is a schematic representation of a servo-control method for servo-controlling the electro-optical camera of the system represented in FIG. 1, taking into account the radar blips.

FIG. 1 schematically represents a mission system dedicated to surveillance and intelligence gathering 10.

This system 10 includes a radar sensor 20 that incorporates a radar 21 and the processing chain 22 thereof.

The processing chain includes a detection module 24 that provides the ability, based on the echoes present in the raw signal delivered by the radar, to extract radar detections, referred to as blips in the following sections of the present patent application in order to distinguish them from the optical detections performed by the electro-optical camera.

The blips provided by the radar sensor are MTI (“Moving Target Information”) blips comprising of a latitude/longitude position based on the WGS 84 (for World Geodetic System 1984) model. The MTI blips are raw data deriving from a radar acquisition without history, that makes it possible to have information on moving targets at any given time. The MTI blips cannot be interpreted without associated radar tracking, in particular in urban or semi-urban areas where the number of moving objects is significant. The blips are raw data that become available rapidly upon an echo being detected.

The radar processing chain includes a tracking module 26 that is capable of developing radar tracks based on the blips obtained as output from the detection module. A track is a detection that is confirmed over a predetermined time interval.

The system 10 includes an electro-optical camera 30 incorporating an optical camera 31 that delivers a certain number of video images per second, and a processing chain 32.

The processing chain 32 includes a detection module 34 that is capable of detecting moving objects from one video image to the next. The detection module generates optical detections, also called objects, as in the following sections.

The processing chain 32 includes a tracking module 36 that is capable of developing optical tracks based on the objects obtained as output from the detection module 34. A track is a detection that is confirmed over a predetermined time interval.

The processing chain 32 includes a servo-control module 37 for following the track of an object chosen as the target object. The servo-control module implements a prediction algorithm for predicting the future or upcoming position of the target object in relation to its instantaneous speed vector. In particular, the servo-control module generates a binary signal indicating either that it continues to receive optical detections that allow it to follow the target object, or that it has lost track of the target object while no longer receiving optical detections. When it is tracking a target object, the servo-control module periodically generates pointing commands for pointing the camera.

The processing chain 32 includes a pointing module 38 for pointing the camera 31 that is capable of orienting the pointing direction of the camera based on a pointing command. This command is either delivered by the servo-control module or by the radar-assisted optical tracking device 50.

The mission system 10 includes a main station 40, which is a computer.

The main station includes a human/machine interface 41 that makes it possible for an operator to interact with the system. This interface includes in particular a display means, such as a screen, for the display of enhanced video images, and an input means, that makes possible the selection of entities displayed on the screen. Preferably, the screen is a touch-screen constituting both a display means as well as an input means, with the operator needing only to touch the screen with their finger in order to select the entity displayed at the corresponding blip on the screen.

The main station 40 includes a radar-assisted optical tracking device 50 that is capable of performing the fusion of the radar data and the optical data and of generating commands for the servo-control of the pointing module 38 of the electro-optical camera 30.

The device 50 comprises an image enhancement module 60 for enhancing of video images delivered by the camera 31 and a additional servo-control module 70 for the servo-control of the camera.

The enhancement module takes as input a video image provided by the camera 31 and the radar blips provided by the detection module 24, and delivers as output an enhanced video image.

The enhancement module includes a transformation means, a correction means, and a superposition means.

The transformation means 62 provides the ability to apply a change of reference frame to the geographic position of the blips in order to pass from a first reference frame associated with the radar 21, to a second reference frame associated with the camera 31, more particularly in the direction of pointing of the camera 31.

The correction means 64 provides the ability to apply a geometric correction to the geographic positions of the blips expressed in the second reference frame linked to the camera in order to take into account the distortion introduced by the optics of the camera 31. The positions in the image thus obtained correspond to the positions of the blips in the video image at the current time instant. These positions in the image are expressed in number of pixels along the directions of the y-axis and the x-axis of the video image.

The superposition means 66 provides the ability to add to the current video image the graphic symbols for each radar blip. The graphic symbol is placed in the video image based on the position in the image of the considered blip delivered by the correction means 64.

The additional servo-control module 70 includes an association means 72 that is capable of associating with a moving object detected by the electro-optical camera 30, a radar blip. For example, the distance, as assessed in the image, between the moving object and a blip, when it is less than a predetermined threshold value makes it possible to effect this association.

The additional servo-control module 70 includes an estimation means 74 that is capable of calculating an estimated blip based on a history of blips associated with a target object of an optical track.

The additional servo-control module 70 includes a servo-control means 76 that is capable of generating, based on the position of a blip in the image, a pointing command and of transmitting the same to the pointing module 38 of the electro-optical camera 30 in order to effect the pointing of the camera.

In the present embodiment, the mission system 10 is integrally installed on board a surveillance aircraft, for example sea surveillance aircraft.

By way of a variant, the device 60 is integrated within the electro-optical camera 30. In this way, the electro-optical camera can be connected directly to the radar sensor 20, and the enhanced video signal is transmitted directly from the output of the electro-optical camera to the human/machine interface of the main station of the mission system.

In another variant embodiment, the electro-optical camera 30 is independent of the radar sensor 20 and the main station 40. For example, the electro-optical camera is installed on board a first light aircraft, in the proximity of the theatre of operation, while the radar sensor is located in a second surveillance aircraft, at a greater distance from the theatre of operation, the main station being located on the ground.

The mission system 10 that has just been presented enables the implementation of a radar-assisted optical tracking method.

This method includes an image enhancement method for enhancing the video images provided by the electro-optical camera 30 with the blips provided by the radar sensor 20, and an additional method for servo—controlling the electro-optical camera, that is complementary to the one of the electro-optical camera 30, based on the blips provided by the radar sensor 20 and associated with a target object.

The electro-optical camera generates video images, detects moving objects, and tracks these moving objects.

The radar sensor generates signals and detects the blips.

At the same time, the enhancement method for enhancing a video image is being implemented.

During the step 110, the enhancement module 60 of the device 50 performs the acquisition of a video image provided by the electro-optical camera as the current video image. It also performs the acquisition of the blips provided by the radar sensor, at the time instant of generation by the electro-optical camera of the current video image.

During the step 120, the geographic position of each blip, expressed in a first reference frame, is transformed into a geographic position expressed in a second reference frame. The second reference frame is linked to the pointing direction of the camera at the time instant of generation of the video image. In order to do this, the transformation means 62 is executed. For example, it uses the current values of the pointing angles of the camera provided by the pointing module 38.

During the step 130, the geographic position of each blip in the second reference frame that is linked to the camera is corrected, in a manner such as to obtain a position in the image. In order to do this, the characteristic optical features of the camera (distortion of the image, aperture, focal length, etc) are taken into account by the correction means 64 during the execution thereof.

The geographic position of each radar blip is thus converted into a position in the image.

During the step 140, for each blip, a graphic symbol is added on the video image acquired during the step 110. In order to do this, the superposition means 66 is executed in a manner so as to embed the graphic symbol at the position in the image of the blip considered.

An enhanced video image is thus obtained, which is displayed during the step 150, on the touch screen of the human/machine interface 41.

Thus, the video images are enhanced with low level radar data, in this case the radar detections, or blips, corresponding to the significant echoes extracted from the radar signal prior to any other processing.

The fusion of the optical and radar data offers a support medium that can be more easily usable and more efficiently exploited by the operator. The latter can rapidly filter the stream of blips originating from the radar, and associate an identification with a radar blip without waiting for the creation of a track by the processing chain of the radar sensor. These enhanced video images make it possible to facilitate the work of selection of an optical target object, and to ensure better optical tracking of this target object.

Advantageously, the graphic symbol is interactive in such a manner that the operator can now manipulate the blips in the images of the video stream of the electro-optical camera.

The method of fusion continues during the step 210 during which the association means 72 is executed in order to associate with each moving object detected by the electro-optical camera 30, a possible blip. A possible blip is a radar blip which could correspond to a moving object detected in the current video image. A priori, the possible blip to be associated with a moving object is the blip that is the nearest to this moving object in the video image.

When such an association is possible, the pieces of information related to the moving object, in particular its speed vector, are assigned to the possible blip.

The radar-assisted optical tracking method includes an additional tracking process, represented in FIG. 3.

During the step 310, the operator selects an optical track from among the tracks provided by the optical tracking module 36. This latter corresponds to the recurrence, through several successive video images, of an object referred to as the target among the moving objects detected by the electro-optical camera.

During the step 320, the geographic position of this target object is transmitted to the servo-control module 37 of the electro-optical camera 30, in a manner so as to generate a suitable command from the pointing module 38 of the camera 31. From this time instant onwards, the electro-optical camera 30 is following the target object.

More precisely, the position of the target object in the image makes it possible to calculate (by means of reverse processing of the transformations and corrections indicated here above) the geographic position thereof. This makes it possible to calculate a distance, an azimuth (direction) and a viewing angle. These set of data are used to enable the servo-control of the camera.

The target object is thus found to be substantially at the centre of the video image.

Then, at each new video image, the process is as follows:

During the step 410, the electro-optical camera 30 seeks to track the target object among the moving objects detected in the current video image.

In the affirmative case, the updated position of the target object is transmitted to the servo-control module of the electro-optical camera, such that it is driven so as to continue to track the target object. The latter remains substantially in the centre of the video image.

In the negative, that is to say, if continuing the optical tracking of the target object by the electro-optical camera is not enabled by any optical detection in the current image, a signal of loss of the optical tracking.

Upon receiving such a signal, during the step 420, the device 50 looks up the history of the possible blips associated with the target object in the preceding video images.

If the device 50 does not find any possible blips associated with this target object in the history, the radar-assisted optical tracking function is not available. The tracking of the target object is therefore not possible.

If on the other hand, during the step 420, the device 50 finds one or more possible blips, then the radar-assisted optical tracking function is available. The pursuit of the target object is carried out on the basis of the radar blips.

More precisely, during the step 430, the estimation means 74 is executed in order to estimate the position of an estimated blip, in the current video image, by using the information related to the possible blips associated with the target object in the preceding video images. The estimation algorithm implemented is, for example, of a Kalman filter type, which is known to the person skilled in the art.

Thereafter, during the step 440, the association means 72 is executed in order to determine if there exists, in the current enhanced video image, a possible blip to be associated with the estimated blip.

If such a possible blip exists, it is recorded and saved as the radar detection of the target object in the current video image.

If such a possible blip does not exist, the estimated blip is recorded and saved as the radar detection of the target object in the current video image.

During the step 450, upon each new radar detection of the target object, the position of the blip that is associated with it is transmitted to the servo-control means 76 in a manner so as to generate an appropriate command intended to be sent to the pointing module 38 of the electro-optical camera 30, in a manner such that it continues to track the target object, even though it may not be possible for the latter to be optically observed by the electro-optical camera 30. On the enhanced video image, the real target corresponding to the target object remains at the centre of the screen of the operator on which the enhanced video stream is displayed.

Thus in the event where the electro-optical camera is no longer capable of detecting and/or tracking a target object, the data and information related to the position of the target object acquired with the radar sensor provide the ability to continue to track the target object by sending these data and information related to the position in the form of a command to the electro-optical camera. The assistance in object tracking makes it possible to improve the performances of the optical tracking of a target object by an optronic sensor, when the visibility of the target object is mediocre, by using the data and information originating from the radar sensor.

Thus, the mission system provided makes it possible to optimally use and combine the data and information originating from a camera and a radar, in order to locate, identify and track a target object of interest, and do this as soon as possible.

In the acquisition phase, the electro-optical camera is advantageous as compared to the radar alone and in the tracking phase, the radar performs with greater efficiency than the electro-optical camera alone (in the event of obstruction of the field of view). Hence the beneficial interest for the system to present all of the data originating from these two sensors.

It is to be emphasised that in the past, the identification of a moving object detected by the radar sensor necessitated the prior creation of a track by the radar sensor in order to distinguish the objects of interest in the potentially significant stream of radar blips. The development of such radar tracks may take time. In addition only a small number of tracks are relevant and correspond to an object looked after.

1. A radar-assisted optical tracking method, implemented within a mission system that comprises (a) an electro-optical camera which generates video images, detects moving objects, and tracks a target object, and (b) a radar sensor which generates signals and detects blips, the radar-assisted optical tracking method comprising:
acquiring a video image generated by the electro-optical camera and blips detected by the radar sensor, wherein said video image is generated and said blips are detected at the same time;
converting a geographic position of each acquired blip, expressed in a first reference frame associated with the radar sensor, into a geographic position of each acquired blip expressed in a second reference frame associated with a pointing direction of the electro-optical camera at the instant of generation of the acquired video image; and
correcting the geographic position of each acquired blip in the second reference frame, according to the characteristic features of the electro-optical camera, in a manner so as to obtain a position of each acquired blip in the acquired video image.

2. The method of claim 1, further comprising:
adding a graphic symbol in the acquired video image for each acquired blip, the graphic symbol being placed in the acquired video image in a manner so as to correspond to the position in the acquired video image of each acquired blip; and
displaying an enhanced image obtained based on the acquired video image and the added graphic symbols.

3. The method of claim 1, further comprising associating each moving object detected by the electro-optical camera with a possible blip, wherein each possible blip is the blip nearest to each moving object in the acquired video image, and wherein each possible blip is augmented with pieces of information related to the associated moving object.

4. The method of claim 3, further comprising estimating, in a current acquired video image, a position of an estimated blip, by using one of the possible blip's pieces of information related to the associated moving object, wherein the associated moving obiect was considered a target object in one or more acquired video images preceding the current acquired video image.

5. The method of claim 4, further comprising associating a second possible blip with each estimated blip, wherein each second possible blip is the blip nearest to each estimated blip in the current acquired video image.

6. The method of claim 4, further comprising servo-controlling the electro-optical camera by making use of the possible blip's pieces of information related to the associated moving obiect, which was considered the target object in the one or more acquired video images preceding the current acquired video image.

7. A mission system having a radar sensor, an electro-optical camera, and a device for acquiring a video image provided by the electro-optical camera and blips detected by the radar sensor, wherein said video image is generated and said blips are detected at the same time the device comprising:
a transformation means for expressing a geographic position of each acquired blip in a first reference frame associated with the radar sensor into a geographic position expressed in a second reference frame associated with a pointing direction of the electro-optical camera at the instant of generation of the acquired video image; and
a position correction means for correcting the geographic position of each acquired blip in the second reference frame outputted from the transformation means, the correction based on characteristic features of the electro-optical camera so as to obtain a position in the acquired video image.

8. The system of claim 7, further comprising:
a superposition means for adding to the acquired video image a graphic symbol for each acquired blip, the graphic symbol being placed into the acquired video image to correspond to the position in the acquired video image of each acquired blip outputted by the position correction means, and
a human/machine display interface for displaying an enhanced video image obtained based on the acquired video image and the added graphic symbol.

9. The system of claim 7, further comprising an association means for associating a possible blip with a moving object detected by the electro-optical camera, wherein each possible blip is the blip nearest to each moving object in the acquired video image, and wherein each possible blip is augmented with pieces of information related to the associated moving object.

10. The system of claim 9, further comprising an estimation means for estimating, in a current acquired video image, a position of an estimated blip, by using one of the possible blip's pieces of information related to the associated moving object, wherein the associated moving object was considered a target object in one or more acquired video images preceding the current acquired video image.

11. The system of claim 10, in which the association means associates a second possible blip with each estimated blip, wherein each second possible blip is the blip nearest to each estimated blip in the current acquired video image.

12. The system of claim 10, further comprising a servo-control means for controlling a pointing module of the electro-optical camera by making use of the possible blip's pieces of information related to the associated moving object, which was considered the target object in the one or more acquired video images preceding the current acquired video image.
